(19) United States
(12) Patent Application Publication
(10) Pub. No.: US 2026/0091346 A1
(43) Pub. Date: Apr. 2, 2026

(54) ROTATING PLATE ARRANGEMENT INTEGRATED WITH A DISC TURBINE

(71) Applicant: SAUDI ARABIAN OIL COMPANY, Dhahran (SA)

(72) Inventors: Karl Kiebel, Novi, MI (US); Esam Hamad, Brighton, MI (US); Alexander Voice, Detroit, MI (US)

(73) Assignee: ARAMCO SERVICES COMPANY, Houston, TX (US)

(21) Appl. No.: 18/901,878

(22) Filed: Sep. 30, 2024

(51) Int. Cl. B01D 53/18; B01D 53/14

(52) U.S. Cl. CPC B01D 53/185; B01D 53/1475; B01D 2257/504

(57) ABSTRACT

Systems and methods for capturing gases are disclosed. The system may include a casing including at least one inlet, a disc turbine and a rotating plate arrangement. The disc turbine is housed inside the casing and comprises a plurality of discs mounted on shaft. The discs of the plurality of discs are spaced apart in axial direction defined by a central axis of the shaft and each of the discs includes at least one disc opening. The discs of the plurality of discs and the shaft are driven rotationally by admitting a solvent through the at least one inlet and into an interior of the casing. The at least one disc opening of each of the plurality of discs guides a flow of introduced gas and the solvent along the axial direction. The rotating plate arrangement is housed in the casing.

### BACKGROUND

Various sectors, such as agriculture and energy production, contribute to the overall global carbon dioxide (CO2) emission. The energy sector, which is powered by fossil fuels, is considered as the largest contributor to CO2 emissions. The transportation sector is also considered as a main contributor to CO2 emissions, mainly from the combustion of jet, diesel and gasoline fuels. CO2 emissions are globally recognized as a contributor to environmental concerns and climate change. Accordingly, CO2 capture and storage as well as CO2 reduction play a major role in decarbonizing global energy systems. CO2 reduction includes improving the efficiency of processes, switching from high-carbon fossil fuels to lower carbon alternatives and reforestation. CO2 capture processes include membrane separations, cryogenic processes, adsorption, and rotating packed bed (RPB) technology.

Rotating packed beds are mainly used to perform gas-liquid contact operations. RPBs typically consist of packing arranged between discs mounted to a central shaft which is connected to an electric motor. CO2 rich gas and solvent are pumped through the RPB in various configurations while the discs are rotating to enhance their mixing. This in turn, facilitates the absorption of CO2 by the solvent. The CO2 rich solvent is then stored in a solvent return for further use or disposal. Alternatively, the CO2 rich solvent is sent to a separator where the CO2 is released from the solvent allowing the reuse of the solvent and the capture of high purity CO2 for usage in a different process or storage.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to systems and methods for capturing gases. In one or more embodiments, the system may include a casing comprising at least one inlet, a disc turbine and a rotating plate arrangement. The disc turbine is housed inside the casing and includes a plurality of discs mounted on shaft. In one or more embodiments, the discs of the plurality of discs are spaced apart in an axial direction defined by a central axis of the shaft and each of the discs includes at least one disc opening. The discs of the plurality of discs and the shaft are driven rotationally by admitting a solvent through the at least one inlet and into an interior of the casing. The at least one disc opening of each of the plurality of discs guides a flow of introduced gas and the solvent along the axial direction. In one or more embodiments, the rotating plate arrangement is housed in the casing and includes a first plate and a second plate that are mounted on the shaft and spaced apart in the axial direction. The first plate includes at least one opening that guides the flow of introduced gas and solvent along the axial direction.

This disclosure presents, in accordance with one or more embodiments, a method for capturing gases. The method may include providing a rotating plate arrangement connected to a disc turbine via a shaft, where the rotating plate arrangement and the disc turbine are housed inside a casing. In one or more embodiments, the rotating plate arrangement includes a first plate and a second plate fixedly mounted on the shaft. The disc turbine includes a plurality of discs mounted on the shaft and the casing includes at least one inlet and at least one outlet. The method further includes admitting a solvent into an interior of the casing through the at least one inlet and introducing a gas into the interior of the casing. In one or more embodiments, the admitted solvent rotationally drives the plurality of discs and the and shaft. In one or more embodiments, at least one disc opening of each of the plurality of discs and at least one plate opening of the first plate guide a flow of the solvent along an axial direction defined by a central axis of the shaft.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 schematically illustrates a system for capturing carbon dioxide.

FIG. 2 shows an arrangement in which a rotating arrangement is connected to a disc turbine via a shaft, in accordance with one or more embodiments.

FIG. 3 shows an apparatus in accordance with one or more embodiments.

FIG. 4 shows an apparatus in accordance with one or more embodiments.

FIG. 5 shows an apparatus in accordance with one or more embodiments.

FIG. 6 shows a flowchart of a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

By way of general background, during various industrial processes, CO2 along with other gases are emitted as a byproduct. In certain cases, CO2 capture processes such as those utilizing rotating packed beds are used to separate the CO2 from other byproducts. Rotating packed beds mainly include packing which is sandwiched between circular plates and designed to enhance mass transfer efficiency between a fluid and a gas. The packing and the plates are housed in a casing and the plates are attached to a shaft which rotates the packing and the plates using a motor. More specifically, the circular motion of the RPB creates shear forces which cause liquid streams to spread-out, break-up into fine droplets, and dissipate across the surface of the packing. This enhances the wetted area available for CO2 absorption, and also enhances mixing in the liquid phase increasing the liquid side mass transfer coefficient. The CO2 rich solvent that leaves the RPB can be further processed to recover the CO2 and then recycled for further use.

Additionally, by way of general background, current RPBs use an electric motor to rotate the plates. The electric motor requires energy to operate and is prone to failure due to a variety of factors such as electrical issues, mechanical failure, external interference, power supply interruption. Thus, it will be appreciated in view of the description below that this and other clear disadvantages of having an electric motor coupled to the RPB are wholly circumvented and obviated via key features of one or more embodiments as described.

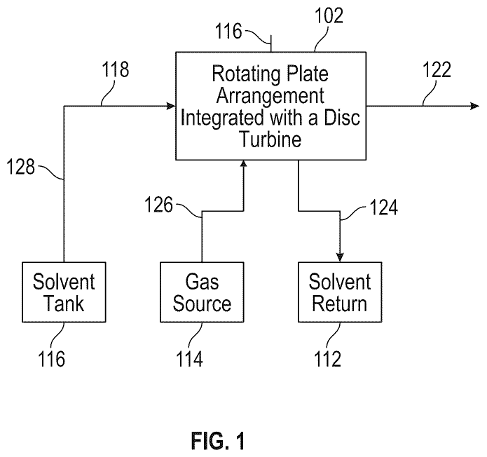

FIG. 1 schematically illustrates a system for capturing carbon dioxide that includes a rotating plate arrangement integrated with a disc turbine (102), in accordance with one or more embodiments. The system for capturing carbon dioxide depicted in FIG. 1 may include a rotating plate arrangement integrated with a disc turbine (102). The rotating plate arrangement integrated with a disc turbine (102) may be connected to a solvent tank (112) and gas source (114) via pipping (118). Furthermore, the rotating plate arrangement integrated with a disc turbine (102) in FIG. 1, may be connected to a solvent return (112) where the CO2 rich solvent (124) is stored. A person skilled in the art will appreciate that system for capturing carbon dioxide depicted in FIG. 1, provided at an industrial facility is for example purposes only. Any configuration of the system for capturing carbon dioxide excluding the rotating plate arrangement integrated with a disc turbine may be used without departing from the scope of the disclosure herein.

In accordance with one or more embodiments, the target gas for capture in the present embodiments may be carbon dioxide (CO2), but may also be other various gases such as sulfur dioxide, nitrogen oxides, ammonia, hydrogen sulfide and hydrogen chloride to name a few. Accordingly, a person skilled in the art will appreciate that a gas (126) comprising CO2 is for example purposes only.

A gas (126) comprising carbon dioxide (CO2) and a solvent (128) with CO2 absorption properties are pumped into the rotating plate arrangement integrated with a disc turbine (102). Once inside, the pressure and velocity of the solvent (128) is utilized to induce the rotation of the rotating plate arrangement integrated with a disc turbine (102) which includes a shaft (116). Furthermore, once the solvent (128) and the gas (126) are in contact, CO2 absorption by the solvent (128) is initiated. The solvent (128) exits the rotating plate arrangement integrated with a disc turbine (102) as a CO2 rich solvent (124) and flows towards the solvent return (112) where it is stored, and the gas (126) exits the rotating plate arrangement integrated with a disc turbine (102) as a CO2 depleted gas (122) to undergo further processing, or release into the atmosphere.

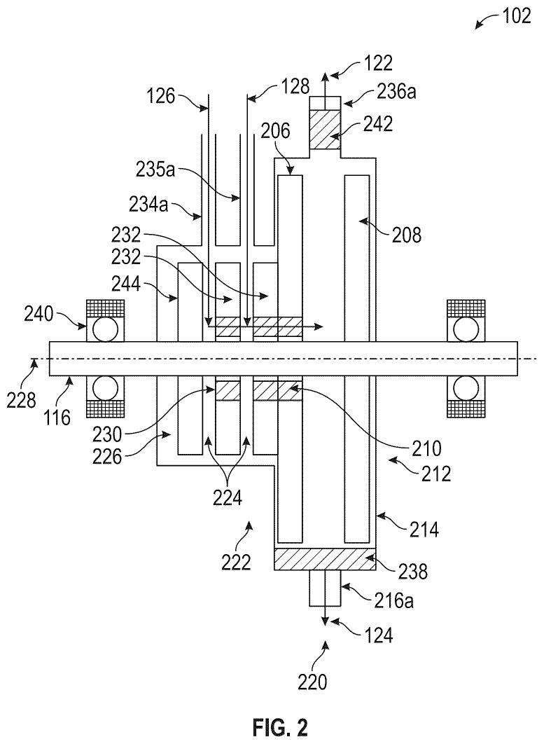

In accordance with one or more embodiments, FIG. 2 schematically illustrates a close-up, cross-sectional elevational view of the rotating plate arrangement integrated with a disc turbine (102) of FIG. 1 which includes a casing (212), a rotating plate arrangement (220) connected to a disc turbine (222) via a shaft (116). The rotating plate arrangement (220) includes a first plate (206) having at least one plate opening (210) that allows the passage of the solvent (128) and gas (126), and a second plate (208). The plates (206, 208) are spaced apart in an axial direction defined by the central axis (228) and are fixedly mounted on the shaft (116). The disc turbine (222) includes a plurality of discs (232) mounted on the shaft (116). The plurality of discs (232) may be formed from corrosive resistant material such as stainless steel. The plurality of discs (232) is spaced apart in an axial direction defined by a central axis (228) of the shaft (116) and each includes at least one disc opening (230) that allows the passage of the solvent (128) and gas (126), except the first disc (244). The casing (212) includes a first inlet (234a) and a second inlet (235a) which may be a multi-feed inlet that permits the flow of the solvent (128) and a gas (126), which includes CO2, into the casing (212). The casing (212) further includes a first outlet (216a) that allows the flow of CO2 rich solvent (124) and a second outlet (236a) that allows the flow of CO2 depleted gas (122).

As such, in accordance with one or more embodiments, a gas (126) comprising CO2 and a solvent (128) that absorbs CO2 are admitted through the first inlet (234a) and the second inlet (235a), into an interior of the casing (226), through the disc channels (224) and towards the disc openings (230). The gas (126) and the solvent (128) may be supplied via a mixing valve where the gas (126) and the solvent (128) are mixed before entering the casing (212). Alternatively, the gas (126) may enter from the first inlet (234a) and the solvent may enter from the second inlet (235a). The pressure and velocity of the solvent (128) induces the rotation of the disc turbine (222) and subsequently the shaft (116) which in turn causes the rotation of the rotating plate arrangement (220). The pressure and velocity of the gas (126) may also be a contributing factor to the rotation of the rotating plate arrangement (220). Meanwhile, the absorption of CO2 by the solvent (128) is initiated once the gas (126) and the solvent (128) come into contact. The gas (126) and the solvent (128) flow in an axial direction defined by a central axis (228) of the shaft (116) through the plate opening (210) and into the rotating plate arrangement (220). The rotation of the rotating plate arrangement (220) enhances the contact between the gas (126) and the solvent (128) by creating dynamic and turbulent conditions and propels both the gas (126) and the solvent (128) away from the central axis (228) of the rotating plate arrangement integrated with a disc turbine (102). The CO2 rich solvent (124) flows towards the sump (238) and exits the casing (212) through the first outlet (216a). The CO2 depleted gas (122) flows towards the mist eliminator (242), where solvent droplets are separated from the CO2 depleted gas (122) and exit the casing (212) through the second outlet (236a).

In accordance with one or more embodiments, the plurality of discs (232) has a diameter smaller than a diameter of the first and second plates (206, 208). Alternatively, the plurality of discs (232) may have a diameter equal or larger than the diameter of the first and second plates (206, 208). The diameters of the plates (206, 208) and discs (232) are selected based on the solvent's flow rate and the rotational speed of the plates (206, 208) required to achieve required CO2 absorption by the solvent (128). Additionally, in accordance with one or more embodiments, the rotating plate arrangement (220) may include three or more plates.

In accordance with one or more embodiments, the first inlet (234a) and the second inlet (235a) may be angled with respect to a tangent of an exterior of the casing (214), to achieve a balance between the torque and the rotational speed of the discs (232) and subsequently enhancing the efficiency of the energy transfer from the solvent (128) to the disc turbine (222).

In accordance with one or more embodiments, the thickness of the discs may be equal to the spacing of the discs. Alternatively, the thickness of the discs may be smaller than the spacing of the discs. A disc turbine (222), having the spacing of the discs smaller than the thickness of the discs, may have enhanced solvent interaction and an increase in the energy transferred however may result in clogging. Alternatively, the thickness of the discs may be larger than the spacing of the discs. A disc turbine (222), having the spacing of the discs larger than the thickness of the discs, may be less prawn to clogging and may have lower friction losses.

In accordance with one or more embodiments, the solvent (128) may be a liquid or a mixture of liquids. Examples include aqueous mixtures of amines such as diethanolamine, 2-amino-2-methyl-propanol, methyl-diethanolamine, and piperazine to name a few. They may also include non-aqueous or water-lean mixtures comprising an organic diluent (such as an alcohol, glycol or imidazole) with an amine, and contain little or no water.

In accordance with one or more embodiments, multiple “stages” may be mounted on the same shaft (116) where each of the stages has an inner radius and an outer radius, allowing liquid from the outlet (outer radius) of the nth stage to be collected and cooler prior to introducing it to the inner radius of the nth+1 stage. Gas (126), by comparison, would be collected from the inner radius of the nth+1 stage and fed to the outer radius of the nth stage, so that the gas and liquid are contacted in a counter-current fashion considering both intra and inter stage flow.

In accordance with one or more embodiments, the rotating plate arrangement integrated with a disc turbine may be provided with a first inlet (234a) and a second inlet (235a) to match the number of disc channels (224). The first inlet and the second inlet (234a, 235a) may be referred to as a multi-channel flow distributor. However, the disc turbine (222) may have a plurality of channels and a plurality of inlets to admit the solvent (128) and the gas (126). Additionally, some of the inlets may be configured to admit only solvent (128) or only gas (126). Alternatively, a single inlet might be used to admit the solvent (128) and the gas (126) to all the disc channels. Any configuration of the inlets may be used without departing from the scope of the disclosure herein.

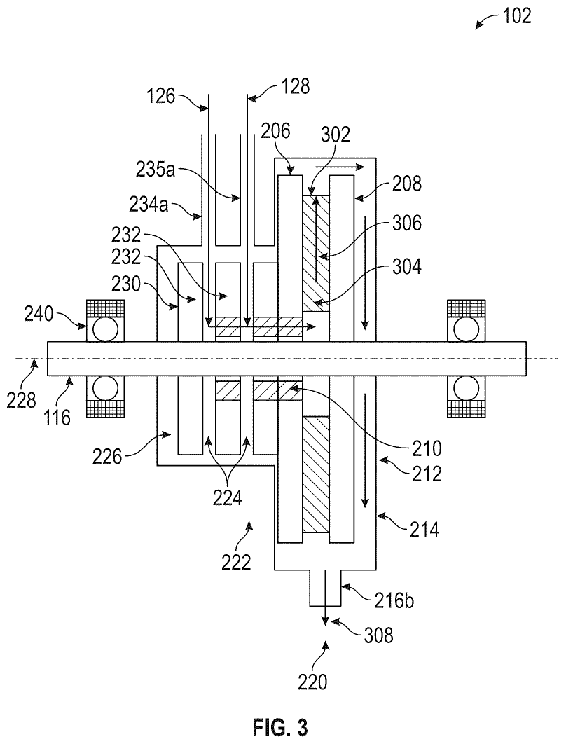

Accordingly, FIGS. 3-5 each show variant arrangements of the rotating plate arrangement integrated with a disc turbine (102), in accordance with one or more embodiments. For general purposes of readability, components shown in FIGS. 3-5 that are the same or similar to components shown in FIGS. 1-2 can be understood as having essentially the same description and function as set forth above, beyond any additional description provided below.

In accordance with one or more embodiments, FIG. 3 shows an arrangement in which a packing (306) is sandwiched between the first plate (206) and the second plate (208) and may be referred to as a rotating packed bed or RPB. Additionally, the casing (212) of the rotating plate arrangement with an integrated disc (102) has a single first outlet (216b) for the exit of CO2 depleted gas and CO2 rich solvent (308). Similarly to FIG. 2, in accordance with one or more embodiments, a gas (126) comprising CO2 and a solvent (128) that absorbs CO2 are admitted through the first inlet (234a) and the second inlet (235a), into an interior of the casing (226), through the disc channels (224) and towards the disc openings (230). The pressure and velocity of the solvent (128) induces the rotation of the disc turbine (222) and subsequently the shaft (116) which in turn causes the rotation of the rotating plate arrangement (220). The pressure and velocity of the gas (126) may also be a contributing factor to the rotation of the rotating plate arrangement (220). Meanwhile, the absorption of CO2 by the solvent (128) is initiated once the gas (126) and the solvent (128) come into contact.

The gas (126) and the solvent (128) flow in an axial direction defined by a central axis (228) of the shaft (116) through the plate opening (210) and into the rotating plate arrangement (220). The rotation of the rotating plate arrangement (220) propels the gas (126) and the solvent (128) away from the central axis (228) of the rotating plate arrangement (220), towards the inner edge (304) of the packing (306), through the packing (306) and toward the outer edge (302). The CO2 depleted gas and CO2 rich solvent (308) flow from the outer edge (302), towards the first outlet (216b) and exit the casing (212).

In accordance with one or more embodiments, the packing (306) promotes the absorption of the carbon dioxide by the solvent (128). The packing (306) enhances the mass transfer efficiency of CO2 by providing a larger contact area between the gas (126) and the solvent (128). Additionally, the rotation of the rotating plate arrangement (220) further enhances the contact between the gas (126) and the solvent (128) by creating dynamic and turbulent conditions.

In accordance with one or more embodiments, packing (306) may be added to a rotating plate arrangement (220) to provide a larger area of interaction between the gas (126) and the solvent (128) which in turn enhances the mass transfer process between the solvent (128) and the gas (126). The packing (306) may be random or regular. Regular and structured packing have higher efficiency and capacity than random packing. Additionally, as packing size increases, mass transfer efficiency increases, and pressure drop may decrease. Furthermore, the packing may be a mesh or wire packing, or any other material with sufficient surface area (around 200-2000 m2/m3). Additionally, in accordance with one or more embodiments, the packing (306) may be removed from the rotating plate arrangement (220) if the required mass transfer is achieved between the solvent (128) and the gas (126).

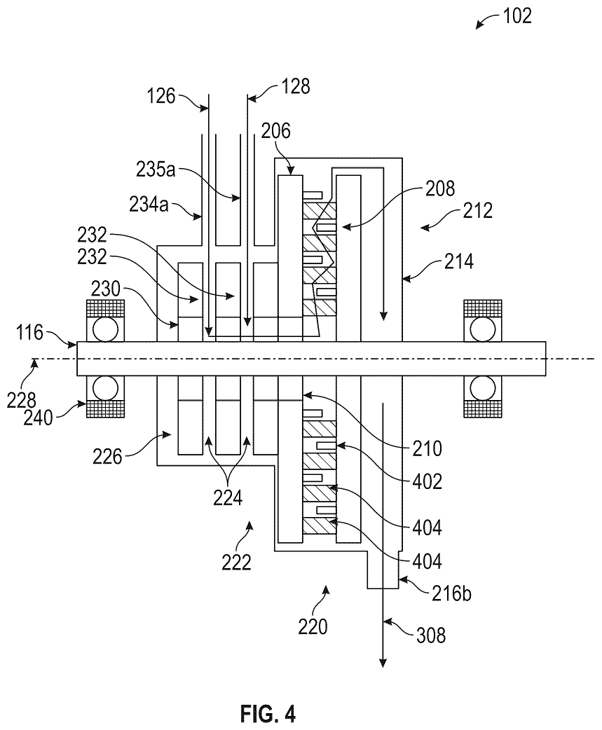

In accordance with one or more embodiments, FIG. 4 shows an arrangement in which a plurality of packings (404) is sandwiched between the first plate (206) and the second plate (208) and are separated by baffles which may be perforated. The baffles permit passage of the solvent (128) and the gas (126) comprising carbon dioxide (CO2). In view of such an arrangement, the rotating plate arrangement having a plurality of packings may be referred to as a rotating packed bed or RPB. Additionally, the casing (212) of the rotating plate arrangement with an integrated disc (102) has a single first outlet (216b) for the exit of CO2 depleted gas and CO2 rich solvent (308). Similarly to FIG. 2, in accordance with one or more embodiments, a gas (126) comprising CO2 and a solvent (128) that absorbs CO2 are admitted through the first inlet (234a) and second inlet (235a), into an interior of the casing (226), through the disc channels (224) and towards the disc openings (230). The pressure and velocity of the solvent (128) induces the rotation of the disc turbine (222) and subsequently the shaft (116) which in turn causes the rotation of the rotating plate arrangement (220). The pressure and velocity of the gas (126) may also be a contributing factor to the rotation of the rotating plate arrangement (220). Meanwhile, the absorption of CO2 by the solvent (128) is initiated once the gas (126) and the solvent (128) come into contact.

The gas (126) and the solvent (128) flow in an axial direction defined by a central axis (228) of the shaft (116) through the plate opening (210) and into the rotating plate arrangement (220). The rotation of the rotating plate arrangement (220) propels the gas (126) and the solvent away from the central axis (228) of the rotating plate arrangement (220), through the packings (404) and the perforated baffles (402) and toward the first outlet (216b). The CO2 depleted gas and solvent rich in carbon dioxide (308) exit the first outlet (216b).

In accordance with one or more embodiments, the packings (404) which provide multiple contact areas between the gas (126) and the solvent (128) and the perforated baffles (402) which improve solvent distribution, enhance the mass transfer efficiency of CO2. Additionally, the perforated baffles (402) may reduce channeling and subsequently enhance the performance of the packings (404). Furthermore, the rotation of the rotating plate arrangement (220) further enhances the contact between the gas (126) and the solvent (128) by creating dynamic and turbulent conditions.

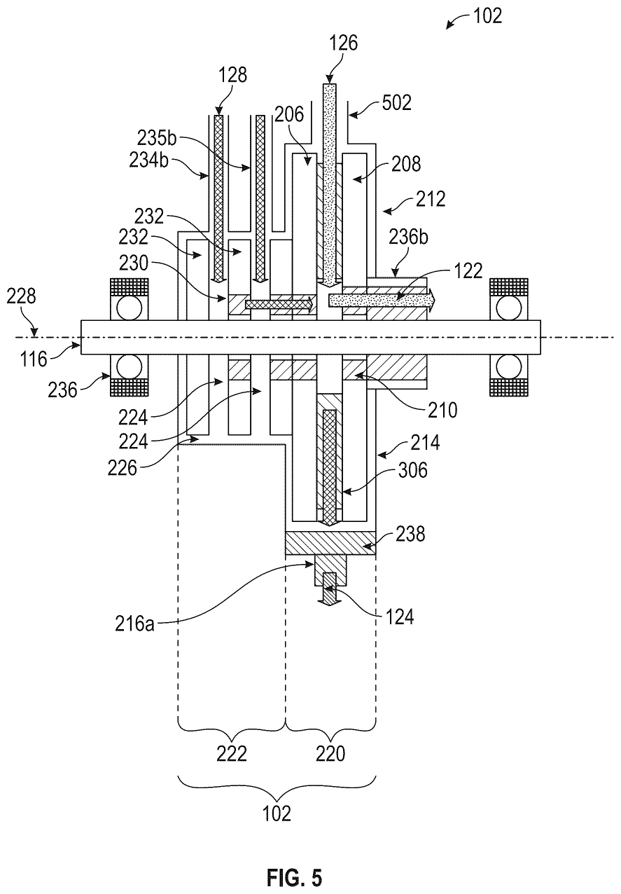

In accordance with one or more embodiments, FIG. 5 shows an arrangement in which packing (306) is sandwiched between the first plate (206) and the second plate (208) and a casing (212) comprising a first inlet (234b) and a second inlet (235b) configured to admit solvent (128) and a third inlet configured to admit a gas (126). Additionally, the casing (212) includes a first outlet (216a) configured to allow CO2 rich solvent (124) to exit the casing (212) and a second outlet (236b) configured to allow the CO2 depleted gas (122) to exit the casing (212). The second outlet (236b) is located circumferentially around the shaft (116). In view of such arrangement, the rotating plate arrangement (220) having a packing (306) may be referred to as a rotating packed bed or RPB.

In accordance with one or more embodiments, a gas (126) comprising CO2 is admitted through a third inlet (502) and a solvent (128) that absorbs CO2 is admitted through a first inlet (234b) and a second inlet (235b). The solvent (128) reaches the interior of the casing (226), the solvent (128) flows through the disc channels (224) and towards the disc openings (230). The pressure and velocity of the solvent (128) induces the rotation of the disc turbine (222), which in turn rotates the shaft (116) which in turn causes the rotation of the rotating plate arrangement (220). The solvent (128) flows in an axial direction defined by a central axis (228) of the shaft (116) through the disc openings (230), through the packing (306) and then towards the first outlet (216a). Meanwhile, the gas (126) flows through the packing (306) and towards the second outlet (236b). The absorption of CO2 by the solvent (128) is initiated once the gas (126) and the solvent (128) come into contact. The CO2 rich solvent (124) is accumulated in a sump (238) and then exits the casing (212) through the first outlet (216a). The CO2 depleted gas (122) exits the casing (212) through the second outlet (236b).

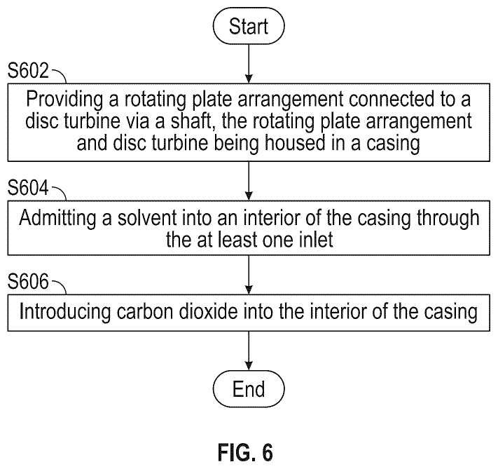

In accordance with one or more embodiments, FIG. 6 depicts a flowchart in accordance with one or more embodiments. More specifically, FIG. 6 illustrates a method for capturing carbon dioxide. Further, one or more blocks in FIG. 6 may be performed by one or more components as described in FIG. 1-5. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Thus, in accordance with one or more embodiments, in step 602, a rotating plate arrangement (220) connected to a disc turbine (222) via a shaft (102) may be provided. The rotating plate arrangement (220) and the disc turbine (222) may be housed in a casing (212). The rotating plate arrangement (220) includes a first plate (206) and a second plate (208) fixedly mounted on the shaft (116). The disc turbine (222) includes a plurality of discs (232) mounted on the shaft (116). The casing (212) may include at least one inlet and at least one outlet. In step 604, a solvent (128) may be admitted into an interior of the casing (226) through at least one inlet. In step 606, carbon dioxide may be introduced into the interior of the casing (226). The admission of the solvent (128) into the interior of the casing (226) rotationally drives the plurality of discs (232) and the shaft. The plurality of discs (232) may each have at least one disc opening (230) and the first plate (206) may have at least one plate opening (210), to potentially guide a flow of the solvent (128) along an axial direction defined by a central axis (228) of the shaft (116).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system for capturing gases, the system comprising:
a casing comprising at least one inlet;
a disc turbine housed in the casing, the disc turbine comprising a plurality of discs mounted on a shaft, wherein the discs of the plurality of discs are spaced apart in an axial direction defined by a central axis of the shaft and each include at least one disc opening, and
wherein the discs of the plurality of discs and the shaft are drivable rotationally, via admitting a solvent through the at least one inlet and into an interior of the casing, and
wherein the at least one disc opening of each of the plurality of discs guides a flow of introduced a gas and the solvent along the axial direction,
a rotating plate arrangement housed in the casing, the rotating plate arrangement comprising a first plate and a second plate fixedly mounted on the shaft and spaced apart in the axial direction, the first plate including at least one plate opening,
wherein the at least one plate opening of the first plate guides the flow of introduced gas and the solvent along the axial direction.

2. The system of claim 1, wherein the gas is carbon dioxide and the solvent is a carbon dioxide absorbent solvent.

3. The system of claim 2, wherein the carbon dioxide is introduced into the interior of the casing through the at least one inlet.

4. The system of claim 1, wherein:
the casing further includes at least one outlet, and
the at least one disc opening of each of the plurality of discs and the at least one plate opening of the first plate guide the flow of introduced carbon dioxide and the solvent toward the at least one outlet.

5. The system of claim 1, wherein the plurality of discs has a diameter smaller than a diameter of the first and second plates.

6. The system of claim 1, wherein the rotating plate arrangement comprises three or more plates.

7. The system of claim 1, wherein the at least one inlet includes an inlet that is angled with respect to a tangent of an exterior of the casing.

8. The system of claim 1, further comprising packing sandwiched between the first and second plates, wherein the packing promotes absorption of the gas by the solvent.

9. The system of claim 8, wherein:
the packing comprises a plurality of packing portions sandwiched between the first and second plate and separated by baffles, and
the baffles are configured to permit passage of the gas and the solvent.

10. The system of claim 4, wherein:
the at least one outlet includes first and second outlets, and
the carbon dioxide flows through the spacing of the first plate and the second plate and towards the second outlet.

11. The system of claim 1, wherein the shaft is supported by a bearing block.

12. The system of claim 1, wherein the casing further comprises a sump that accumulates the solvent.

13. A method for capturing gases, the method comprising:
providing a rotating plate arrangement connected to a disc turbine via a shaft, the rotating plate arrangement and disc turbine being housed in a casing;
wherein the rotating plate arrangement comprises a first plate and a second plate fixedly mounted on the shaft,
wherein the disc turbine comprises a plurality of discs mounted on the shaft, and
wherein the casing comprises at least one inlet and at least one outlet, admitting a solvent into an interior of the casing through the at least one inlet;
introducing a gas into the interior of the casing;
wherein admitting the solvent rotationally drives the plurality of discs and the shaft, and
wherein at least one disc opening of each of the plurality of discs and at least one plate opening of the first plate guide a flow of the solvent along an axial direction defined by a central axis of the shaft.

14. The method of claim 13, wherein the gas is carbon dioxide.

15. The method of claim 14, wherein the rotating plate arrangement comprises a packing sandwiched between the first plate and the second plate and promotes absorption of the carbon dioxide by the solvent.

16. The method of claim 13, wherein each disc of the plurality of discs have a diameter smaller than a diameter of the first and second plates.

17. The method of claim 13, wherein each disc of the plurality of discs are spaced apart, from another, along an axial direction of the shaft.

18. The method of claim 14, wherein the carbon dioxide is absorbed by the solvent in the interior of the casing.

19. The method of claim 13, wherein the shaft is supported by a bearing block.

20. The method of claim 14, wherein the solvent is a carbon dioxide absorbent solvent.
